(19) United States
(12) Patent Application Publication
(10) Pub. No.: US 2022/0110302 A1
(43) Pub. Date: Apr. 14, 2022

(54) COLLAPSIBLE BAIT NET

(71) Applicant: Yunior Dominguez, Hialeah, FL (US)

(72) Inventor: Yunior Dominguez, Hialeah, FL (US)

(21) Appl. No.: 17/067,015

(22) Filed: Oct. 9, 2020

(51) Int. Cl. A01K 75/00; A01K 73/00; A01K 97/05

(52) U.S. Cl. CPC A01K 75/00; A01K 97/05; A01K 73/00

(57) ABSTRACT

The present invention is a collapsible bait net comprising netting mounted to a flexible flat metal bar or blade joined at its ends by a fastening means to form a closed hoop net assembly that maintains its shape and structural integrity. The assembly includes six stabilizing cords positioned equidistant from each other along the circumference of the closed hoop, which cords converge at the center of the assembly, and are connected to each other by a fastening means. The six stabilizing cords are connected to a single draw cord which is used to cast the bait net into a desired depth of water then pull it back. The assembly collapses for easy storage by rotating or twisting into a double figure 8 configuration having three sections that are folded onto each other from top to bottom to create three smaller overlapping closed hoops.

### STATEMENT REGARDING FEDERALLY SPONSORED RESEARCH OR DEVELOPMENT

This invention has been created without the sponsorship or funding of any federally sponsored research or development program.

### FIELD OF INVENTION

The present invention relates generally to fishing bait nets and in particular to collapsible bait nets for easy storage and transport.

### BACKGROUND

In the fishing industry, whether for sport or for profit, bait nets are used to capture small fish and/or sea creatures for use as bait to attract bigger fish such as marlin, tuna, tarpon or similar fish. The bait nets usually used by fishermen come in varying forms, sizes, and shapes, but invariable are too cumbersome to store and transport. In particular, the bait nets used to catch larger bait need to be sturdy and able to withstand the rigors of being cast into the ocean from a moving or stationary vessel, dragged through water, and pulled back into a boat. In instances where the bait net is sturdy enough to handle this rigorous activity, they are not easily stored on or off the boat or transportable from one venue to another. The rigid construct of most good bait nets results in rapid deterioration through sun exposure or tearing due to improper storage on a boat or in a garage or other location not suitable to protect the delicate netting.

The present invention solves these problems by providing a collapsible hoop net that is strong and sturdy to endure the rigors of capturing bait, and which is capable of being stored and transported with ease. The essential feature of this invention allows for the collapsing of the hoop net for easy and efficient storage on the boat in a location that minimizes sun exposure and rapid deterioration. Alternatively, the collapsible/folded hoop net may be stored in another location or may be packaged in a protective casing.

### SUMMARY OF THE INVENTION

The present invention serves to improve upon existing bait nets and address the storage and transport challenges facing the industry without sacrificing the strength and rigidity the bait net.

The present invention is a collapsible bait net or hoop net comprised of netting that is affixed or mounted to a flexible flat metal bar having two ends that are connected to each other or joined together to form one complete ring or hoop that maintains its shape and integrity. The two ends of the flexible flat metal bar connect seamlessly by a fastening means which allow(s) the entire assembly to function as intended. Additionally, the attachment of the net about the flexible flat metal bar is designed to evenly distribute weight and improve the overall balance of the assembly. The flexible flat metal bar has the appearance and dimensions similar to that of a blade, meaning it is flat, thin, and long. The flexible flat metal bar or blade may be coated with rubber or a rubber like material to facilitate the attachment of the net. The net, when affixed to the flexible flat metal bar or blade, extends in a conical shape, creating a hoop or enclosed receptacle for capturing and holding live bait as they are pulled from the water into a boat. Further, the hoop net and flexible flat metal bar or blade are combined with other components of the invention, including six stabilizing cords positioned equidistant along the circumference of the hoop created by the connected or joined ends of the flexible flat metal bar or blade, which cords converge at the center of the hoop by a fastening means to a single draw cord. The draw cord is used to cast or lower the assembled hoop net into the water to a desired depth and to pull the hoop net back into the boat with or without bait inside the net. Once the hoop net assembly has been used, the flexible flat metal bar is twisted or rotated to form a double FIG. 8 which allows for the hoop net to collapse or fold onto itself to form three smaller rings or hoops. Once the ends are joined, the flexible flat metal bar or blade is not disconnected in order to collapse the bait net, and it's flexibility allows for the repeated folding and unfolding or collapsing of the hoop net into three smaller rings or hoops for easy storage in a bin on the boat or protective casing designed to accommodate the folded or collapsed bait net.

### BRIEF DESCRIPTION OF THE DRAWINGS

The accompanying drawings incorporated in and forming a part of the specification, illustrate several aspects of the present invention, and together with the description serve to explain the principles of the invention. In describing the invention, reference will at times be made to the accompanying drawings in which:

FIG. 1 is a perspective view of the present invention fully assembled, not in its collapsed state;

FIG. 2A is a front perspective view of the flexible flat metal bar of the present invention, with the ends not joined;

FIG. 2B is a magnified perspective view of the unassembled fastening means of the flexible flat metal bar of the present invention;

FIG. 2C is a magnified perspective view of the assembled fastening means of the flexible flat metal bar of the present invention;

FIG. 3A is a perspective view of the assembled fastening means joining the ends of the flexible flat metal bar of the present invention, to form a closed hoop;

FIG. 3B is a perspective view of the flexible flat metal bar of the present invention as a closed hoop, without netting, in a figure 8 configuration;

FIG. 3C is perspective view of the flexible flat metal bar of the present invention as a closed hoop, without netting, in a double figure 8 configuration;

FIG. 3D is a front perspective view of the flexible flat metal bar of the present invention as a closed hoop, without netting, folded into three smaller hoops for purposes of illustrating the folding/collapsing feature;

FIG. 3E is a front perspective view of the flexible flat metal bar of the present invention as a closed hoop, without netting, in its completely folded/collapsed state;

FIG. 4A is a perspective view of the assembled fastening means joining the ends of the flexible flat metal bar of the present invention to form a closed hoop, with netting attached to the flexible flat metal bar;

FIG. 4B is a perspective view of the flexible flat metal bar as a closed hoop, with netting attached, in a figure 8 configuration;

FIG. 4C is a perspective view of the flexible flat metal bar as a closed hoop, with netting attached, in a double figure 8 configuration;

FIG. 4D is a front perspective view of the flexible flat metal bar of the present invention as a closed hoop, with netting, folded into three smaller hoops for purposes of illustrating the folding/collapsing feature; and

FIG. 4E is a front perspective view of the flexible flat metal bar of the present invention as a closed hoop, with netting, in its completely folded/collapsed state.

### DESCRIPTION OF THE INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments and is not intended to be limiting.

The details of one or more embodiments of the invention are set forth in the accompanying drawings and the description below. Other features, objects, and advantages of the invention will be apparent from the description and drawings, and from the claims. In the following description, numerous specific details are set forth to provide a thorough understanding of the embodiments. One skilled in the art to which this invention belongs will recognize, however, that the techniques described can be practiced without one or more of the specific details, or with other methods, components, materials, etc. In other instances, well known structures, materials or operations are not shown or described in detail to avoid obscuring certain aspects.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

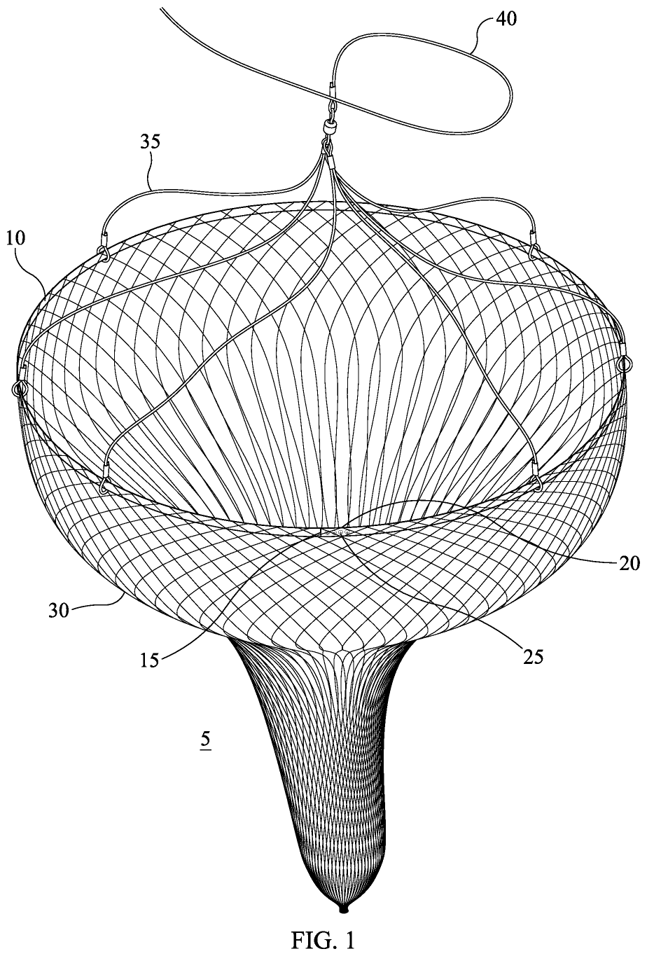

As shown in FIG. 1, the present invention is a collapsible bait net or hoop net 5 comprised of a flexible flat metal bar or blade 10, with two ends 15 and 20 which join together by way of a fastening means 25 to form the ring or hoop of the bait net 5; netting 30 that is affixed to the flexible flat metal bar or blade 10; six stabilizing cords 35 which are attached to the flexible flat metal bar 10 and are positioned equidistant from each other; and a draw cord 40 that connects the six stabilizing cords 35 together at their point of convergence. As shown in FIG. 1, the fully assembled bait net or hoop net 5 comprises a large ring or hoop 10 formed by joining the two ends 15, 20 of the flexible flat metal bar or blade 10 by a fastening means 25, with netting 30 and six stabilizing cords 35 attached to the flexible flat metal bar or blade 10 and a draw cord 40 connected to the six stabilizing cords 35. The netting 30 is interwoven onto or about the flexible flat metal bar 10 before the two ends 15, 20 are fastened together. Alternatively, the flexible flat metal bar 10 may be coated with rubber or a rubber-like substance that creates a surface for the netting 30 to adhere to by sewing or gluing. The fastening means 25 may be semi-permanent, whereby the ends 15, 20 of the flexible flat metal bar 10 are disconnected to change the netting 30; or permanently whereby the ends 15, 20 of the flexible flat metal bar 10 cannot be disconnected. The six stabilizing cords 35 are positioned equidistant from each other on the large ring or hoop of the bait net 5. The net or netting 30 extends into a conical shape, creating a hoop or enclosed receptacle for capturing and holding live bait as they are pulled from the water into a boat. The draw cord 40 is then attached to the six stabilizing cords 35 to complete the assembly. Alternatively, the draw cord 35 may be attached to the stabilizing cords 35 before the six stabilizing cords 35 are attached to the large hoop of the bait net 5. In other embodiments of this invention, the hoop net assembly 5 may have less than or greater than six draw cords depending on the dimensions of the flexible flat metal bar 10 and netting 30.

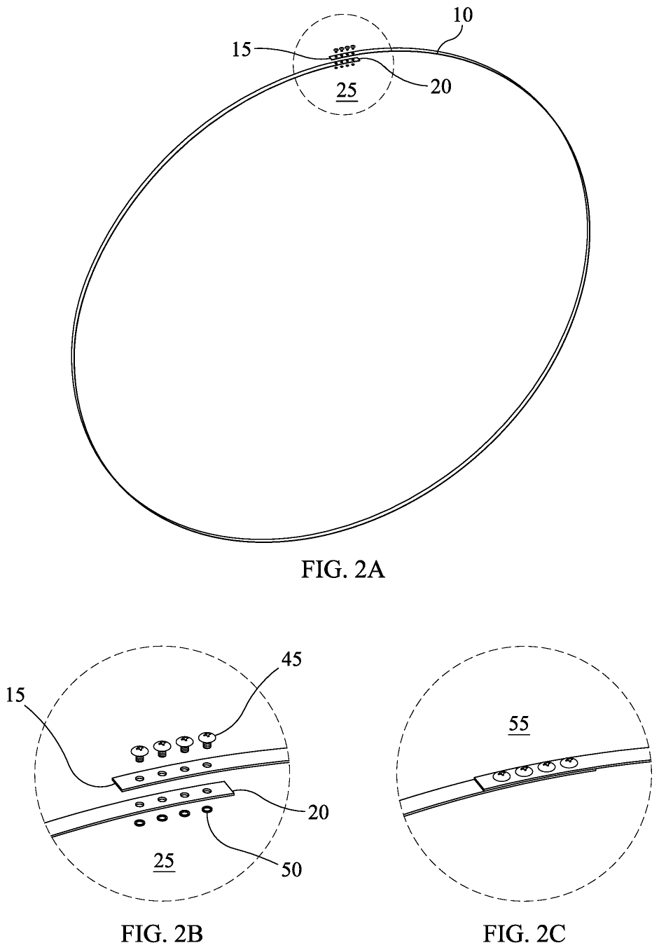

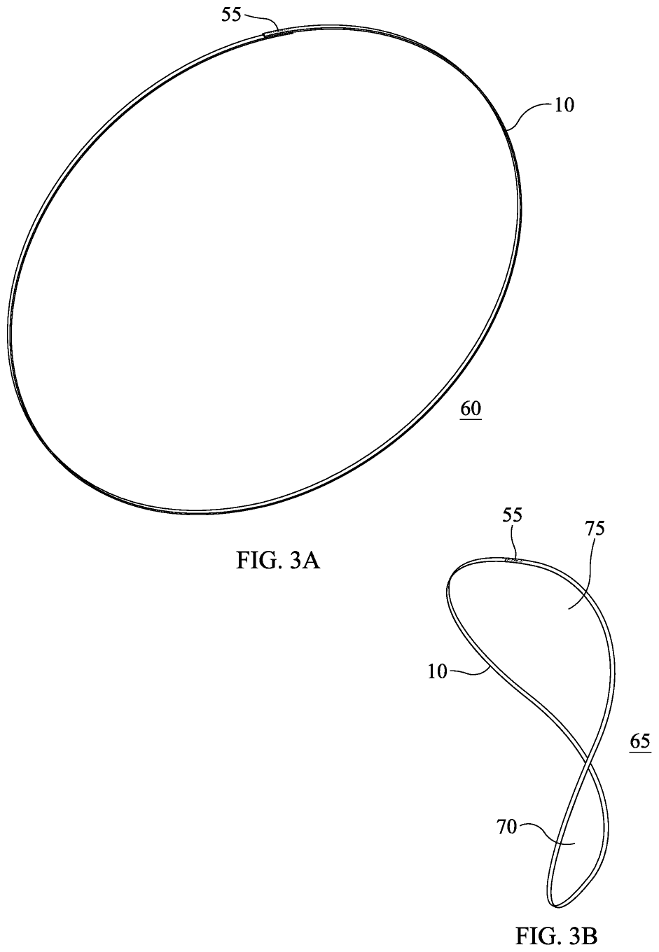

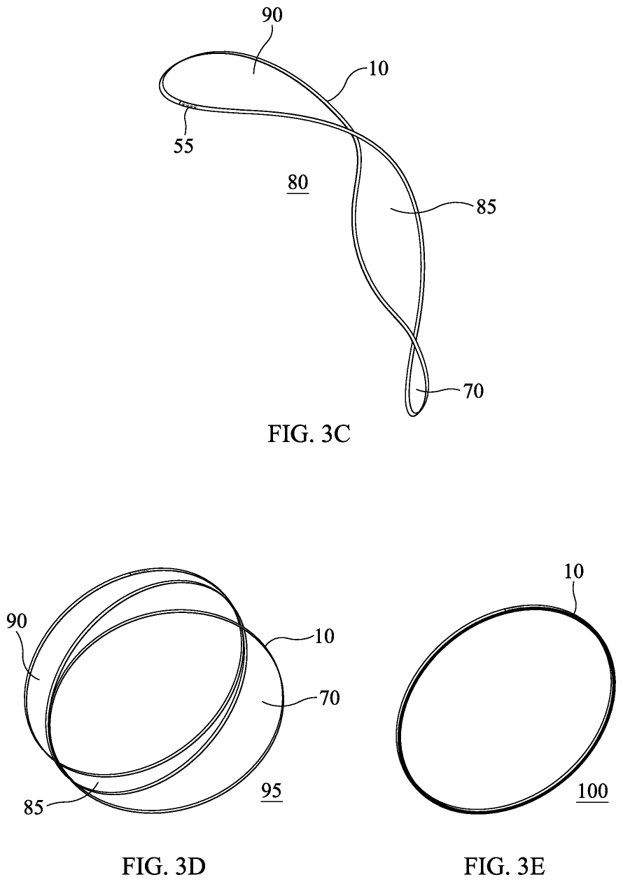

As shown in FIGS. 2A, 2B, and 2C, the two ends 15 and 20 of the flexible flat metal bar or blade 10 are joined together by a fastening means 25. In FIG. 2B, the fastening means 25 consists of bolts 45 and nuts 50 whereby the two ends 15 and 20 of the flexible flat metal bar or blade 10 each have four drilled holes, and the ends 15 and 20 are positioned together in an overlapping manner whereby the drilled holes line up in a corresponding manner for inserting the bolts 45 through the drilled holes on both ends 15, 20. As shown in FIG. 2C, the nuts 50 are attached to the bolts 45 generating a completely assembled fastening means 55, which securely joins the two ends 15, 20 of the flexible flat metal bar or blade 10, resulting in one contiguous ring or hoop 60 as shown in FIG. 3A. In other embodiments of this invention the fastening means 25 may comprise of or utilize a rivet system that permanently joins the two ends 15, 20 in lieu of nuts and bolts which may be semi-permanent. Alternatively, the two ends 15, 20 may be joined together by welding, gluing, or other fastening means known by one of ordinary skill in the field of fasteners.

In this embodiment of the present invention, the material for the flexible flat metal bar or blade 10 is 17-4 PH Stainless Steel. The tensile strength and flexibility of this 17-4 PH Stainless Steel material allows the hoop formed by joining the two ends 15, 20 of the metal bar or blade 10 to maintain its shape, integrity, and rigidity during use and handling. The 17-4 PH Stainless Steel combines the optimal amount of strength, toughness, flexibility, and resistance to corrosion. The flexible flat metal bar or blade 10 may have a length of 12 feet, a width of 10 mm, and a thickness of 1 mm. In other embodiments of the present invention, the flexible flat metal bar 10 may be comprised of an amalgam of metals and carbon to generate a 1070 rated carbon steel which also allows for the flexibility, toughness, and strength required. Other embodiments of this invention may include the use of metal alloys, plastics, fiberglass, epoxy, or carbon fiber, or other materials known to one of ordinary skill in the art to which this invention belongs. In other embodiments of the invention, the flexible flat metal bar or blade 10 may have different dimensions whereby the length may be lesser or greater than 12 feet, the width may be lesser or greater than 10 mm, and the thickness may be lesser or greater than 1 mm.

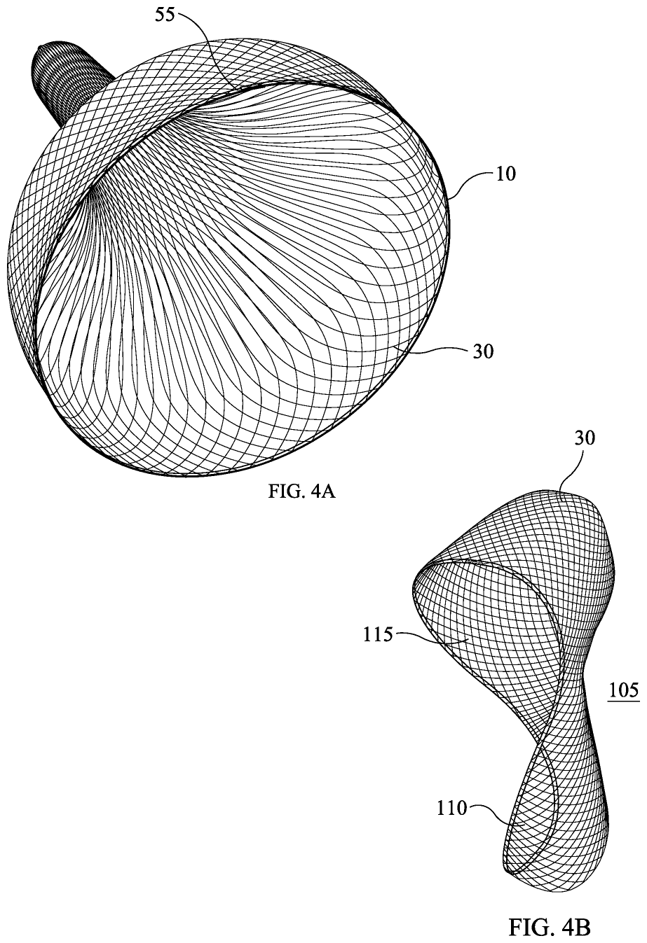

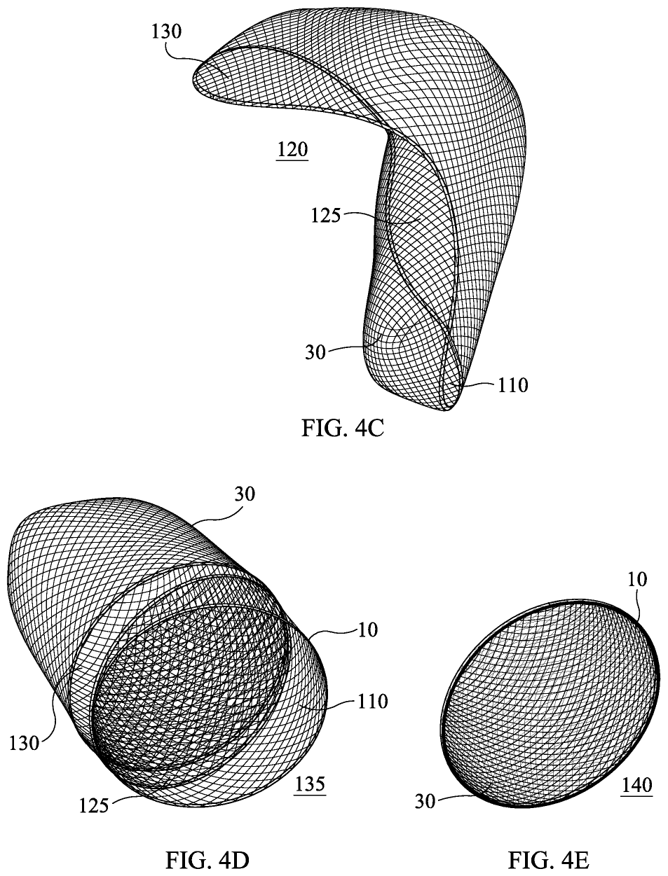

The level of flexibility of the flexible flat metal bar 10 is very important to the ability of the bait net 5 to collapse or fold and unfold repeatedly without breaking or warping. The assembled bait net 5 collapses into three smaller rings or hoops to facilitate storage and transport, as shown in FIGS. 3A, 3B, 3C, 3D, 3E, 4A, 4B, 4C, 4D, and 4E. For purposes of illustration, FIGS. 3A, 3B, 3C, 3D, and 3E demonstrate the steps by which the bait net 5, without the netting 30, collapses and/or folds to form the three smaller rings or hoops. First, a user holds the assembled hoop 60 of the bait net 5 at the top by the assembled fastener 55 and stabilizes it at the bottom with one foot, then from the top, the user twists or rotates the flexible flat metal bar or blade 10 to form a figure 8 65 having two sections, a bottom or first section 70 and a top or second section 75; then the user further twists or rotates the top or second section 75, dividing it into two sections to form a double figure 8 80, thus creating a middle or new second section 85 and a new top or third section 90. The user then folds the top section 90 onto the middle section 85 then finally onto the bottom section 70 to form a partially collapsed hoop 95 as illustrated in FIG. 3D. FIG. 3E illustrates the completely folded or collapsed hoop 100 without the netting.

For purposes of illustration, FIGS. 4A, 4B, 4C, 4D, and 4E demonstrate the same steps by which the bait net 5, with the netting 30, collapses and/or folds to form three smaller rings or hoops. First, a user holds the flexible flat metal blade 10 of the bait net 5 at the top by the assembled fastener 55 and stabilizes it at the bottom with one foot, then twists or rotates the flexible flat metal bar or blade 10 to form a figure 8 105 having two sections, a bottom or first section 110 and a top or second section 115; then the user further twists or rotates the top or second section 115, dividing it into two sections, forming a double figure 8 120, thus creating a middle or new second section 125 and a new top or third section 130. The user then folds the top section 130 onto the middle section 125 then finally onto the bottom section 110 to form a partially collapsed hoop net 135 as illustrated in FIG. 4D. FIG. 4E illustrates the completely folded or collapsed hoop net 140.

The present invention does not come apart in order to collapse or fold, rather it is assembled with a semi-permanent or permanent fastener and collapses on itself and/or folds onto itself to reduce its surface area, making it compact for easy storage and transport. Once assembled, the components of the present invention are not disconnected or detached for purposes of achieving collapsibility. The ability of the assembled bait net 5 to collapse or fold easily 100, 140 (as shown in FIGS. 3E and 4E) is facilitated by the tensile strength and flexibility of the flat metal bar 10. The flexible flat metal bar 10 allows the entire apparatus to be twisted, rotated, or manipulated to form three smaller symmetrical rings or hoops. This allows for the collapsing of the entire apparatus in a few simple steps versus disconnecting parts or components of the hoop net 5 to achieve a collapsed state.

In the embodiments of the invention described herein the net or netting 30 may comprise of ¼″ mesh made of monofilament; and the six stabilizing cords 35 may be made of 3001b. monofilament. The six stabilizing cords 40 converge to the center of the bait net 5 and are fastened together by means of a 10/0 stainless steel swivel and is further attached to the draw cord 40 which draw cord 40 may also be made of 3001b. monofilament that is 25 feet long and ¼″ thick. The disclosed materials and dimensions of the components of the bait net 5 are not meant to be limiting, but illustrative and may be adjusted by one of ordinary skill in the art to which this invention belongs for optimal function.

In the embodiments of the present invention disclosed herein, the net or netting 30 may be made of mesh or similar fibers woven into a diamond-like structure or lattice-like structure as shown in FIG. 1. However, in other embodiments of this invention the type of fiber used, and its pattern of weaving may be altered or substituted by one of ordinary skill in the art to which this invention belongs to achieve optimal function. The disclosed materials and dimensions of the components of the bait net 5 are not meant to be limiting, but illustrative and may be adjusted by one of ordinary skill in the art to which this invention belongs for optimal function.

In other embodiments of this invention, the net or netting 30 may comprise of materials including, but not limited to monofilament nylon, multifilament nylon, monofilament polyethylene nylon, multifilament polyethylene, knotless polyethylene netting, and/or clear twisted polyethylene. The net or netting 30 may comprise of any material synthetically derived or manufactured to have the same or similar structure and properties similar to that of nylon and/or polyethylene. Further, the net or netting 30 may comprise of other similar nylon and/or polyethylene materials known to one of ordinary skill in the art to which this invention belongs, including the art of marine netting.

In other embodiments of this invention, the net 5 may comprise of materials including, but not limited to monofilament nylon, multifilament nylon, monofilament polyethylene nylon, multifilament polyethylene, knotless polyethylene netting, and/or clear twisted polyethylene. Further the net 5 may comprise of other similar nylon and/or polyethylene materials or netting. The net 5 may comprise of any material synthetically derived or manufactured to have the same or similar structure and properties similar to that of nylon and/or polyethylene.

In the embodiment of this invention described herein and/or other embodiments of this invention, the cords (35, 40) may be made of monofilament. In other embodiments the cords (35,40) are not limited to this material, but may comprise of nylon or other material having the same or similar tensile strength and thickness of ordinary fishing line or other material of same or similar properties known to one of ordinary skill in the art to which this invention belongs. Further, the cords 35, 40 may comprise of materials including, but not limited to monofilament nylon, multifilament nylon, monofilament polyethylene nylon, multifilament polyethylene, knotless polyethylene netting, and/or clear twisted polyethylene. The cords 35, 40, may comprise of other similar nylon and/or polyethylene materials or netting. The cords 35, 40, may comprise of any material synthetically derived or manufactured to have the same or similar structure, tensile strength, and other properties similar to that of monofilament and/or nylon and/or polyethylene.

As various changes may be made in the above-described subject matter without departing from the scope and the spirit of the invention, it is intended that all subject matter contained in the above description, or shown in the accompanying drawings, will be interpreted as descriptive and illustrative, and not in a limiting sense. Many modifications and variations of the present invention are possible in light of the above teachings. It is therefore to be understood that within the scope of the appended claims, the invention may be practiced otherwise than as specifically described.

### EQUIVALENTS

Those skilled in the art will recognize or be able to ascertain using no more than routine experimentation, many equivalents to the specific embodiments of the invention described herein. Such equivalents are intended to be encompassed by the claims.

What is claimed is:

1. A collapsible bait net comprising:
a. a flexible flat metal blade having two ends that are joined together to form a hoop;
b. a fastening means that joins the two ends of the flexible flat metal blade to form a closed hoop;
c. a net made of mesh, having a bottom portion and a top portion, which top portion has a diameter that is equal to the diameter of the hoop and which bottom portion has a diameter that is less than the diameter of the hoop, and extends into a conical shaped enclosed receptacle; and
d. a hoop net assembly that is formed by attaching the net to the hoop created by the joining of the two ends of the flexible flat metal blade; and
e. six stabilizing cords, each separately attached to the flexible flat metal blade of the hoop net assembly and positioned equidistant from each other, and which cords converge at the center of the hoop net assembly; and
f. a draw cord that is attached to the six stabilizing cords at their point of convergence; and
g. a mode of collapsing the hoop net assembly for ease of storage and transport without the disassembly of any of its components whereby: a user holds the flexible flat blade of the hoop net assembly at the top by the fastening means and stabilizes the assembly at the bottom with one foot, then from the top, the user rotates the flexible flat metal blade to form a figure 8, creating two sections, a bottom section and a top section; then the user further rotates the top section to create two sections, a middle section and a new top section, resulting in a double figure 8 configuration; then the new top section is folded onto the middle section, which is then folded onto the bottom section to form three overlapping hoops; and the three hoops comprise the collapsed configuration of the bait net.

2. The collapsible bait net in claim 1 whereby the fastener is comprised of nuts and bolts whereby two or more holes are drilled on each end of the flexible flat metal blade, which ends are arranged in a corresponding overlapping manner to facilitate the insertion of the bolts into and through the corresponding drilled holes and the nuts are fastened to the bolts to join the two ends of the flexible flat metal blade.

3. The collapsible bait net in claim 1 whereby the fastener is a rivet system whereby two or more holes are drilled on each end of the flexible flat metal blade, which ends are arranged in a corresponding overlapping matter to facilitate the insertion of rivets into and through the corresponding drilled holes and the rivets are fastened to join the two ends of the flexible flat metal blade.

4. The collapsible bait net in claim 1 whereby the two ends of the flexible flat metal blade are fastened together by gluing.

5. The collapsible bait net in claim 1 whereby the two ends of the flexible flat metal blade are fastened together by welding.

6. The collapsible bait net in claim 1 whereby the flexible flat metal blade is made of 17-4 PH Stainless Steel.

7. The collapsible bait net in claim 1 whereby the flexible flat metal blade is made of 1070 rated carbon steel.

8. The collapsible bait net in claim 1 whereby the flexible flat metal blade is made of metal alloy.

9. The collapsible bait net in claim 1 whereby the flexible flat metal blade is made of carbon polymer.

10. The collapsible bait net in claim 1 whereby the flexible flat metal blade is made of carbon fiber.

11. The collapsible bait net in claim 1 whereby the flexible flat metal blade is made of epoxy.

12. The collapsible bait net in claim 1 whereby the flexible flat metal blade is made of fiberglass.

13. The collapsible bait net in claim 1 whereby the flexible flat metal blade has a length of 4 inches or greater, a width of 5 mm or greater, and a thickness of 0.5 mm or greater.

14. A collapsible bait net comprising:
a. a flexible flat bar having two ends that are joined together to form a hoop;
b. a fastening means that joins the two ends of the flexible flat bar to form a closed hoop;
c. a net made of mesh, having a bottom portion and a top portion, which top portion has a diameter that is equal to the diameter of the hoop and which bottom portion has a diameter that is less than the diameter of the hoop, and extends into a conical shaped enclosed receptacle; and
d. a hoop net assembly that is formed by attaching the net to the hoop created by the joining of the two ends of the flexible flat bar; and
e. six stabilizing cords, each separately attached to the flexible flat bar of the hoop net assembly and are positioned equidistant from each other about the hoop net assembly, and which cords converge at the center of the hoop net assembly; and
f. a draw cord that is attached to the six stabilizing cords at their point of convergence; and
g. a mode of collapsing the hoop net assembly for ease of storage and transport without the disassembly of any of its components whereby: a user holds the flexible flat bar of the hoop net assembly at the top by the fastening means and stabilizes the assembly at the bottom with one foot, then from the top, the user rotates the flexible flat bar to form a figure 8, creating two sections, a bottom section and a top section; then the user further rotates the top section to create two sections, a middle section and a new top section, resulting in a double figure 8 configuration; then the new top section is folded onto the middle section, which is then folded onto the bottom section to form three overlapping hoops;
and the three hoops comprise the collapsed configuration of the bait net.

15. The collapsible bait net in claim 1 whereby the fastener is comprised of nuts and bolts whereby two or more holes are drilled on each end of the flexible flat bar, which ends are a arranged in a corresponding overlapping manner to facilitate the insertion of the bolts into and through the corresponding drilled holes and the nuts are fastened to the bolts to join the two ends of the flexible flat bar.

16. The collapsible bait net in claim 1 whereby the fastener is a rivet system whereby two or more holes are drilled on each end of the flexible flat bar, which ends are arranged in a corresponding overlapping matter to facilitate the insertion of rivets into and through the corresponding drilled holes and the rivets are fastened to join the two ends of the flexible flat bar.

17. The collapsible bait net in claim 1 whereby the two ends of the flexible flat bar are fastened together by gluing.

18. The collapsible bait net in claim 1 whereby the two ends of the flexible flat bar are fastened together by welding.

19. The collapsible bait net in claim 1 whereby the flexible flat bar is made of 17-4 PH Stainless Steel.

20. The collapsible bait net in claim 1 whereby the flexible flat bar is made of 1070 rated carbon steel.

21. The collapsible bait net in claim 1 whereby the flexible flat bar is made of a metal alloy.

22. The collapsible bait net in claim 1 whereby the flexible flat bar is made of carbon polymer.

23. The collapsible bait net in claim 1 whereby the flexible flat bar is made of durable plastic.

24. The collapsible bait net in claim 1 whereby the flexible flat bar is made of carbon fiber.

25. The collapsible bait net in claim 1 whereby the flexible flat bar is made of epoxy.

26. The collapsible bait net in claim 1 whereby the flexible flat bar is made of fiberglass.

27. The collapsible bait net in claim 1 whereby the flexible flat bar has a length of 4 inches or greater, a width of 5 mm or greater, and a thickness of 0.5 mm or greater.
